(19) United States
(12) Patent Application Publication
(10) Pub. No.: US 2010/0193638 A1
(43) Pub. Date: Aug. 5, 2010

(54) ANGULAR PROFILE FOR SKIN SECURING OF A BODY

(76) Inventors: Vicente Martinez Valdegrama, Alpedrete (Madrid) (ES); Francisco de Paula Burgos Gallego, Pinto (Madrid) (ES)

Correspondence Address: WENDEROTH, LIND & PONACK, L.L.P., 1030 15th Street, N.W.,, Suite 400 East, Washington, DC, 20005-1503, US

(21) Appl. No.: 12/607,527

(22) Filed: Oct. 28, 2009

(30) Foreign Application Priority Data
Jan. 30, 2009 (ES) P200900282

(51) Int. Cl. B64C 1/12; F16S 1/02; B64C 9/00

(52) U.S. Cl. 244/132; 52/582.1; 244/87

(57) ABSTRACT

The angular profile consists of sections (4) arranged one after another joined to each other, in order to simplify the connections between said sections (4).

It is characterized in that the adjacent ends of each section (4) present in one of their sides an extension (7) complementary to a recess (8) provided in the same side of the end of the adjacent section (4) for locating the extension (7) in the recess (8) and, by means of bolted joints (9), to fix the extension (7) in the opposite side of the adjacent section (4) constituting the profile.

The sections (4) and the bolted joints (9) are made of metal to provide electrical continuity.

The angular profile constitutes the trailing edge of a tail rudder (1) of an HTP of an aircraft.

### OBJECT OF THE INVENTION

The invention relates to an angular profile conceived to form an edge for finishing and securing the skin of a body, and which consists of sections of profile arranged one after another, which are joined to each other and which have the aim of simplifying the join between the different sections of profile.

In general, the invention is applicable in any sector of industry in which the securing of the skin which has to cover a body is done by means of an angular profile consisting of sections of profile arranged one after another. More specifically, the invention is applicable in the aeronautical sector, for example in order to effect the join between the skins of the rudder of an HTP (Horizontal Tail Plane) of an aircraft, in which the profile constitutes the trailing edge.

### BACKGROUND OF THE INVENTION

The securing between the skins of the rudder of an HTP of an aircraft is currently done by means of a “U”-shaped angular profile, which constitutes the trailing edge of the rudder, in such a way that the latter is formed from different sections of profile in order to be able to absorb the curvature of the actual skins more easily. Moreover, the different sections have to be joined together in order to provide electrical continuity along the entire trailing edge of the rudder, as set down in the existing regulations for conducting possible electrical discharges produced by storms. The different sections are conventionally known as clips.

The join of the different sections of profile constituting the trailing edge of the rudder is effected by means of an additional plate of small dimensions which is secured with rivets. For that purpose, the zones to be joined of the adjacent sections constituting the profile have to be cleaned since the existing primer layer has to be removed from the zones in contact.

Moreover, the additional piece remains superimposed on the sections constituting the trailing edge, which produces a greater aerodynamic resistance caused by the relief of that piece. Furthermore, this relief creates a poor aesthetic appearance.

### DESCRIPTION OF THE INVENTION

In order to achieve the objectives and resolve the drawbacks stated above, the invention has developed a new angular profile for securing the skin of a body, which comprises at least two angular sides that define an edge for finishing and securing the skin, and which furthermore consists of sections of profile arranged one after another, which are joined to each other.

The main novelty of this invention lies in the fact that the adjacent ends of each of the sections constituting the angular profile present in one of their sides an extension with a configuration complementary to a recess provided in the same side of the end of the adjacent profile, in such a way that this configuration permits the extension to be located in the recess, which means that the join between the different sections constituting the profile can be effected by means of bolted joints which secure that extension in the opposite side of the adjacent profile section, thereby materializing the join between the different sections.

In the preferred embodiment of the invention, the profile presents a “U”-shape configuration, which includes the extension in one of the ends of one of its sides, while the opposite end of that same side includes the recess which means that the join between different adjacent sections can be made by locating the extension of one section in the recess of the adjacent section.

Moreover, in the preferred embodiment, the extension and the recess present complementary rectangular configurations which occupy a portion of one of the sides of the end zones, but it is obviously evident to an average expert in the subject that such an extension and recess can have any complementary configuration that would permit the said function to be carried out such as for example a triangular configuration, curved, irregular, etc.

Furthermore, in the preferred embodiment the sections that constitute the profile are made of an electrically conducting material. Equally, the bolted joints are made of an electrically conducting material such that the joins of the sections constituting the profile present electrical continuity.

The bolted joints are materialized by means of rivets.

In a preferred embodiment of the invention the angular profile that is described constitutes the trailing edge of a tail rudder of an HTP of an aircraft, in such a way that by means of the securing rivets electrical continuity is obtained along the entire trailing edge of the tail rudder, as set down in the existing regulations.

This novel configuration also provides better aerodynamics in the aircraft since there does not exist any projection in the trailing edge, due to dispensing with the conventional securing pieces which are left superimposed forming reliefs the trailing edge.

Moreover, the elimination of these securing pieces constitutes a reduction in weight and of assembly times, apart from providing an improved aesthetics in the final result.

Below, in order to facilitate a better understanding of this descriptive specification and forming an integral part thereof, a series of figures is attached in which the object of the invention has been represented by way of illustration and non-limiting.

### BRIEF DESCRIPTION OF THE FIGURES

FIG. 1. Shows a perspective view of one of the parts constituting the rudder of an HTP of a conventional aircraft.

FIG. 2. Shows a detail of how the join is carried out in the state of the art by means of an additional piece of two sections which constitute the trailing edge of the rudder.

FIG. 3. Shows an exploded perspective view of the new configuration of the profile sections which constitute the trailing edge of the rudder.

FIG. 4. Shows a view equivalent to the previous figure in which the join has been made between two consecutive sections of the profile by means of rivets, such that electrical continuity is provided between the sections.

### DESCRIPTION OF THE PREFERRED FORM OF EMBODIMENT

Given below is a description of the invention based on the figures mentioned above.

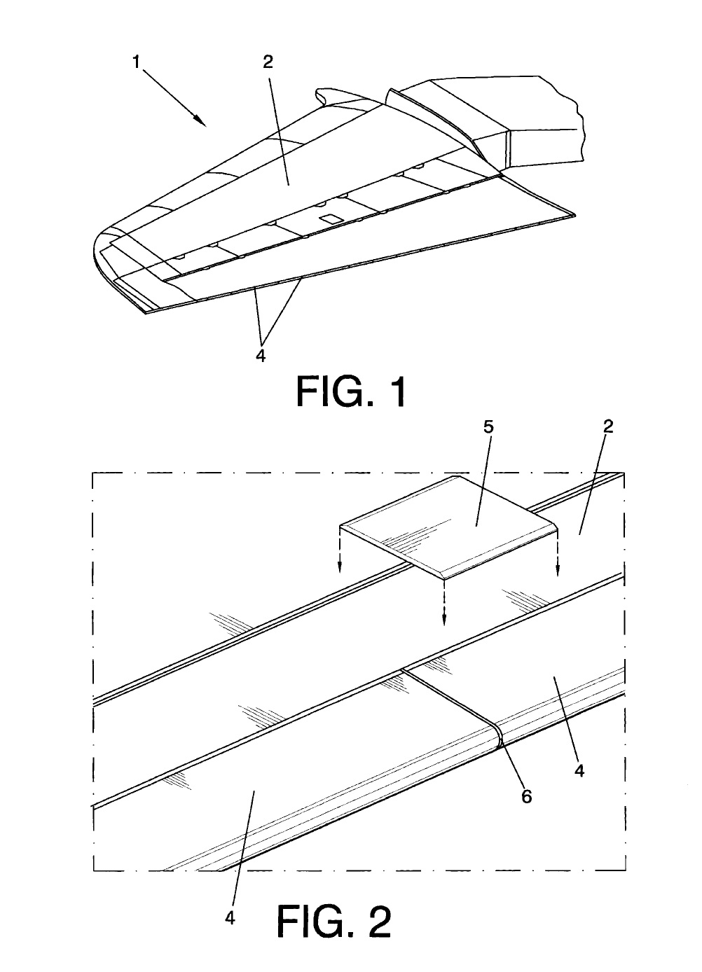

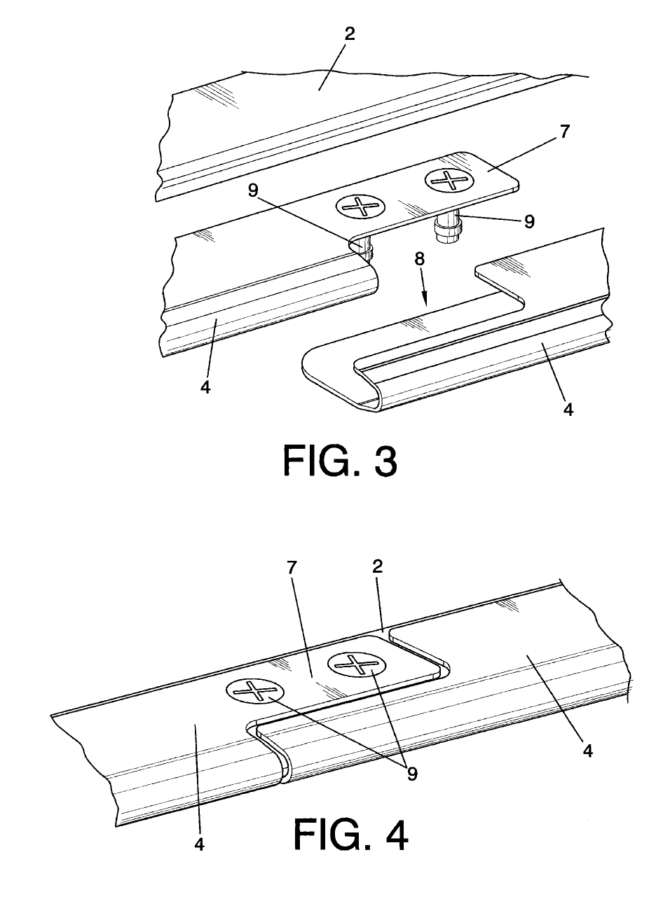

FIG. 1 shows a part 1 of the HTP rudder in which a skin 2 is provided which is secured in the rear part by means of a profile 3 which constitutes the trailing edge and is defined by sections 4.

In the state of the art, the sections 4 present a “U”-shaped cross-section and they are joined by means of an additional plate 5 which is fixed by means of rivets in a way that is superimposed on the adjacent sections 4 on the zone 6 in which they are joined, while the additional plate 5 forms a relief.

This configuration presents the drawbacks described above, and which are solved by means of the invention; for which the sections 4 with a “U”-shaped cross-section present a novel configuration defined by the incorporation of an extension 7 in one of the sides of one of the ends of the sections 4, while in that same side and at the opposite end it incorporates a recess 8 complementary to the extension 7 in such a way that two adjacent sections 4 are arranged with the extension 7 being located in the recess 8, and all this in such a way that the skin 2 is covered, with which, by using rivets 9, the securing is effected between the metallic sections 4 and their attachment to the skin 2, by traversing and being fixed in the extension 7 and in the opposite side of the adjacent section 4, all this such that electrical continuity is obtained along the entire trailing edge.

This configuration provides a simplified structure with regard to that described in the state of the art, and it contributes the advantages mentioned earlier.

1. ANGULAR PROFILE FOR SKIN SECURING OF A BODY, which comprises at least two angular sides that define an edge for finishing and securing the skin (2), and which consists of sections (4) of profile arranged one after another, which are coupled to each other via coupling means; wherein the adjacent ends of each section (4) present in one of their sides an extension (7) of configuration complementary to a recess (8) provided in the same side of the end of the adjacent section (4), in order to locate the extension (7) in the recess (8) and, the coupling means consisting essentially of bolted joints (9), for securing the extension (7) in the opposite side of the adjacent section (4) which constitutes the profile.

2. ANGULAR PROFILE FOR SKIN SECURING OF A BODY, according to claim 1, wherein the profile has a “U”-shaped configuration, each of which sections (4) presents in one of the ends of one of its sides the extension (7), and in the same side and in the opposite end the recess (8).

3. ANGULAR PROFILE FOR SKIN SECURING OF A BODY, according to claim 1, wherein the extension (7) and the recess (8) present complementary rectangular configurations which occupy a portion of one of the sides of the end zones.

4. ANGULAR PROFILE FOR SKIN SECURING OF A BODY, according to claim 1, wherein the extension (7) and the recess (8) present complementary configurations selected from among triangular, curved, irregular, and combination of the above.

5. ANGULAR PROFILE FOR SKIN SECURING OF A BODY, according to claim 1, wherein the sections (4) that constitute the profile are made of an electrically conducting material and the bolted joints (9) are likewise made of an electrically conducting material in order to provide electrical continuity for the securing of those sections (4).

6. ANGULAR PROFILE FOR SKIN SECURING OF A BODY, according to claim 5, wherein the bolted joints (9) are rivets.

7. ANGULAR PROFILE FOR SKIN SECURING OF A BODY, according to claim 1, wherein the angular profile constitutes the trailing edge of a tail rudder of an HTP (Horizontal Tail Plane) of an aircraft.

8. ANGULAR PROFILE FOR SKIN SECURING OF A BODY, according to claim 2, wherein the angular profile constitutes the trailing edge of a tail rudder of an HTP (Horizontal Tail Plane) of an aircraft.

9. ANGULAR PROFILE FOR SKIN SECURING OF A BODY, according to claim 3, wherein the angular profile constitutes the trailing edge of a tail rudder of an HTP (Horizontal Tail Plane) of an aircraft.

10. ANGULAR PROFILE FOR SKIN SECURING OF A BODY, according to claim 4, wherein the angular profile constitutes the trailing edge of a tail rudder of an HTP (Horizontal Tail Plane) of an aircraft.

11. ANGULAR PROFILE FOR SKIN SECURING OF A BODY, according to claim 5, wherein the angular profile constitutes the trailing edge of a tail rudder of an HTP (Horizontal Tail Plane) of an aircraft.

12. ANGULAR PROFILE FOR SKIN SECURING OF A BODY, according to claim 6, wherein the angular profile constitutes the trailing edge of a tail rudder of an HTP (Horizontal Tail Plane) of an aircraft.
